(19) United States
(12) Patent Application Publication
(10) Pub. No.: US 2002/0089414 A1
(43) Pub. Date: Jul. 11, 2002

(54) Delivery indicator system

(76) Inventors: Bruce F. Boggs, St. Louis, MO (US); John M. Bode, St. Louis, MO (US)

Correspondence Address: Michael S. Neustel, Suite No. 4, 2534 South University Drive, Fargo, ND, 58103, US

(21) Appl. No.: 09/756,974

(22) Filed: Jan. 9, 2001

Related U.S. Application Data
(60) Provisional application No. 60/213,606, filed on Jun. 21, 2000.

(51) Int. Cl. G08B 5/00

(52) U.S. Cl. 340/286.11; 340/332

(57) ABSTRACT

A delivery indicator system for assisting delivery personnel in locating a delivery location. The delivery indicator system includes a housing, a display for illustrating messages, a control unit electrically connected to the display, and an attaching member secured to the rear of the housing for attaching to a surface of an object. The display may be comprised of an illuminated semi-transparent sheet, LED or LCD devices for illustrating messages and/or images. The control unit may be in communication via the Internet or an Intranet for allowing remote control of the control unit. After an order for goods such as but not limited to pizza, the consumer then activates the display which illustrates a message for the delivery person to easily locate.

### CROSS-REFERENCE TO RELATED U.S. PATENT APPLICATION

I hereby claim benefit under Title 35, United States Code, Section 119(e) of U.S. provisional patent application Serial No. 60/213,606 filed Jun. 21, 2000 entitled “Delivery Indicator Light”. This application is a continuation-in-part of the No. 60/213,606 application. The No. 60/213,606 application is currently pending. The 60/213,606 is incorporated by reference into this patent application.

### BACKGROUND OF THE INVENTION

1. Field of the Invention

The present invention relates generally to delivery devices and more specifically it relates to a delivery indicator system for assisting delivery personnel in locating a delivery location.

2. Description of the Prior Art

Address indicators have been in use for years to assist people in locating a specific location. Conventional address indicators are typically comprised of the building address attached to the exterior surface of the building to indicate the address of the building. Additional locations for receiving address indicators are mailboxes and windows.

Conventional address indicators are difficult to locate by individuals unfamiliar with a specific location. Another problem is that conventional address indicators are difficult to read from a distance or during darkness. Another problem is that delivery personnel spend additional time and resources attempting to locate a specific address when delivering various items such as but not limited to pizza, flowers, packages and various other items.

Examples of patented devices which are illustrative of such prior art include U.S. Pat. No. 5,831,522 to Weed et al; U.S. Pat. No. 4,901,461 to Edwards et al; U.S. Pat. No. 5,911,524 to Wilton; U.S. Pat. No. 4,611,265 to Davis; U.S. Pat. No. 5,001,455 to Starchevich; U.S. Pat. No. 4,323,879 to Kelley; U.S. Pat. No. 5,699,039 to Korzen; U.S. Pat. No. 5,657,004 to Whittaker et al; U.S. Pat. No. 5,489,887 to Porras; U.S. Pat. No. 4,003,040 to Browand; U.S. Pat. No. 3,810,170 to Zinsmeister; U.S. Pat. No. 6,000,811 to Bordak; U.S. Pat. No. 6,119,622 to Banerjea; U.S. Pat. No. 5,325,279 to Freelove et al.

While these devices may be suitable for the particular purpose to which they address, they are not as suitable for assisting delivery personnel in locating a delivery location. Conventional address indicators are not suitable for providing efficient guidance to delivery personnel attempting to delivery goods.

In these respects, the delivery indicator system according to the present invention substantially departs from the conventional concepts and designs of the prior art, and in so doing provides an apparatus primarily developed for the purpose of assisting delivery personnel in locating a delivery location.

### SUMMARY OF THE INVENTION

In view of the foregoing disadvantages inherent in the known types of delivery indicator devices now present in the prior art, the present invention provides a new delivery indicator system construction wherein the same can be utilized for assisting delivery personnel in locating a delivery location.

The general purpose of the present invention, which will be described subsequently in greater detail, is to provide a new delivery indicator system that has many of the advantages of the delivery indicator devices mentioned heretofore and many novel features that result in a new delivery indicator system which is not anticipated, rendered obvious, suggested, or even implied by any of the prior art delivery indicator devices, either alone or in any combination thereof.

To attain this, the present invention generally comprises a housing, a display for illustrating messages, a control unit electrically connected to the display, and an attaching member secured to the rear of the housing for attaching to a surface of an object. The display may be comprised of an illuminated semi-transparent sheet, LED or LCD devices for illustrating messages and/or images. The control unit may be in communication via the Internet or an Intranet for allowing remote control of the control unit. After an order for goods such as but not limited to pizza, the consumer then activates the display which illustrates a message for the delivery person to easily locate.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a delivery indicator system that will overcome the shortcomings of the prior art devices.

A second object is to provide a delivery indicator system for assisting delivery personnel in locating a delivery location.

Another object is to provide a delivery indicator system that can be easily attached to various objects such as but not limited to a door, mailbox or window.

An additional object is to provide a delivery indicator system that reduces the need for delivery personnel to look for address numbers.

A further object is to provide a delivery indicator system that is easily seen by delivery personnel from various distances.

Another object is to provide a delivery indicator system that promotes efficient delivery of goods to a specific location.

A further object is to provide a delivery indicator system that indicates to the consumer when the delivery of the goods is in route.

Another object is to provide a delivery indicator system that is capable of displaying various messages and/or images.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an upper perspective view of the present invention attached to a conventional mailbox.

FIG. 3 is a front view of the present invention attached to the window within a door.

FIG. 4 is a front view of the present invention.

FIG. 5 is a front cutaway view showing the power source and illuminating light.

FIG. 6 is a side view of the present invention showing a magnet for attaching to metallic objects.

FIG. 7 is a side view of the present invention showing a suction cup for attaching to smooth surfaces.

FIG. 8 is a side view of the present invention showing a clip member that may also serve as a stand.

FIG. 9 is a block diagram of the present invention.

### DESCRIPTION OF THE PREFERRED EMBODIMENT

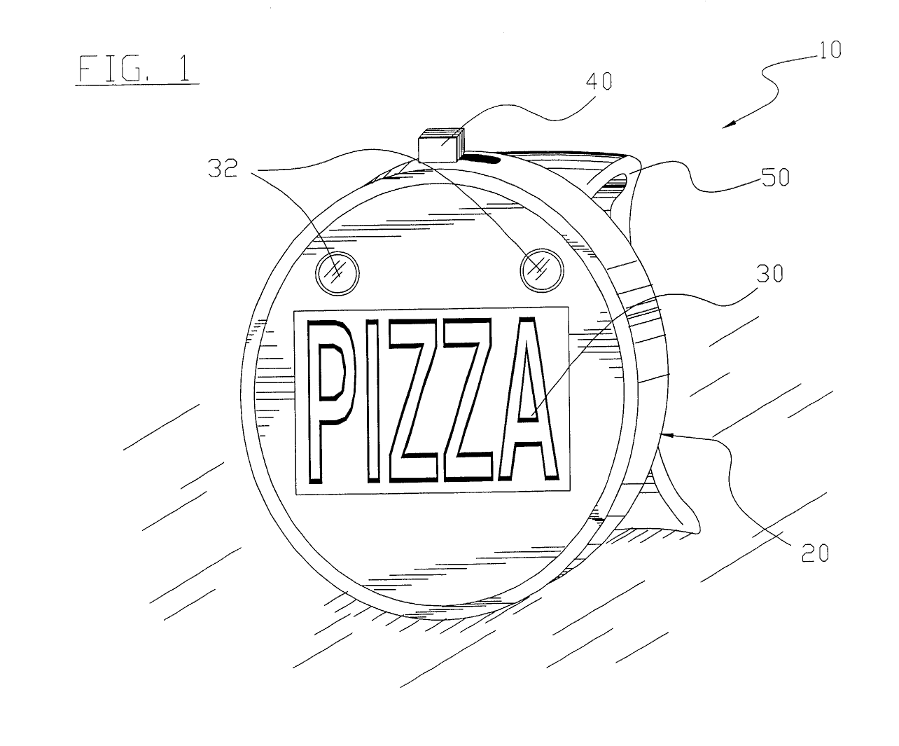

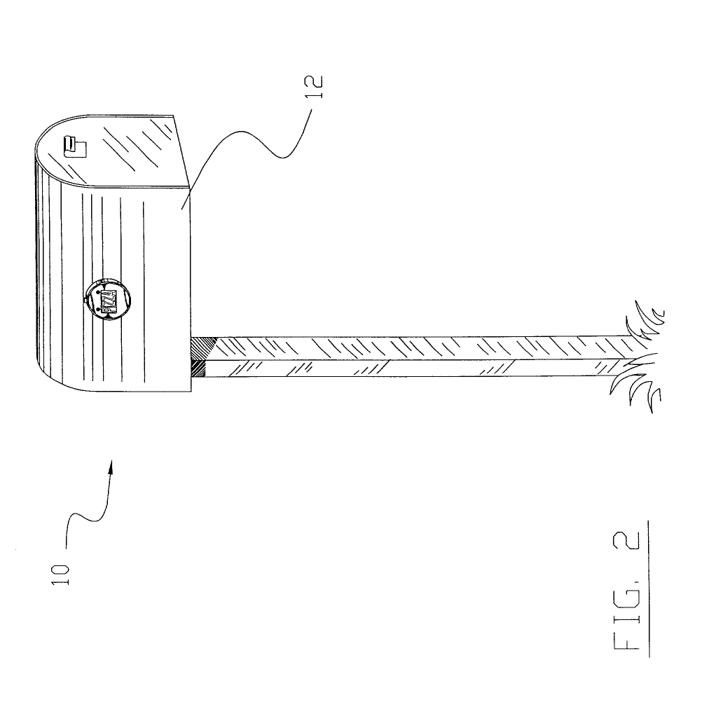

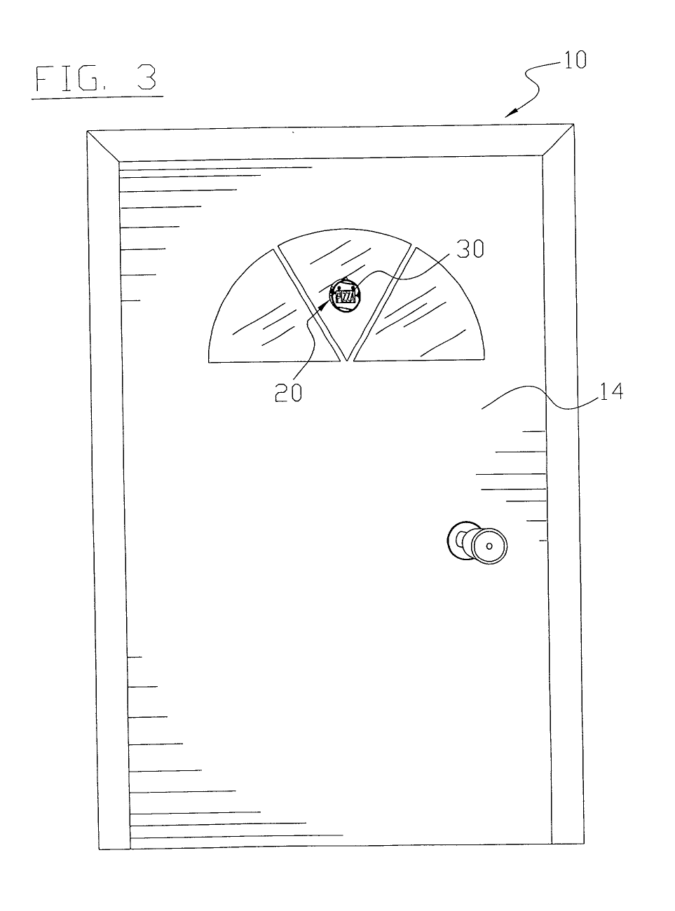

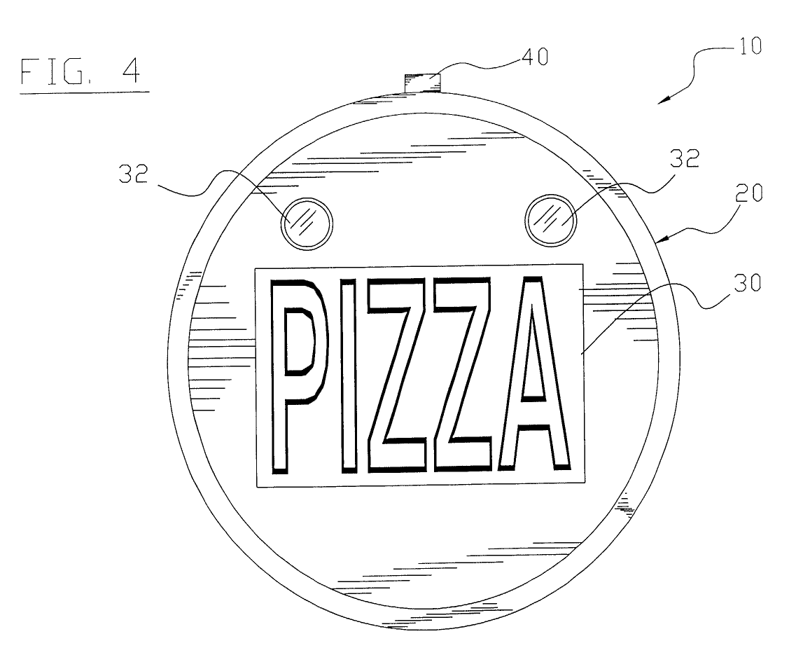

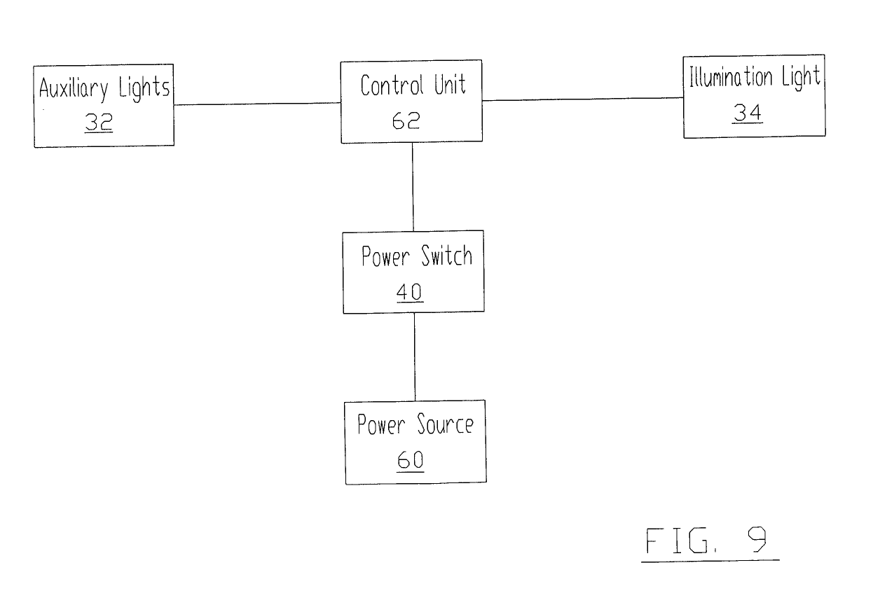

Turning now descriptively to the drawings, in which similar reference characters denote similar elements throughout the several views, FIGS. 1 through 9 illustrate a delivery indicator system 10, which comprises a housing 20, a display 30 for illustrating messages, a control unit 62 electrically connected to the display 30, and an attaching member secured to the rear of the housing 20 for attaching to a surface of an object. The display 30 may be comprised of an illuminated semi-transparent sheet, LED or LCD devices for illustrating messages and/or images. The control unit 62 may be in communication via the Internet or an Intranet for allowing remote control of the control unit 62. After an order for goods such as but not limited to pizza, the consumer then activates the display 30 which illustrates a message for the delivery person to easily locate.

The control unit 62 is a general-purpose digital processor that controls the operation of the display 30. Control unit 62 can be a single-chip processor or implemented with multiple components. Using instructions retrieved from memory, the control unit 62 controls the reception and manipulations of input data and the output and display 30 of data on output devices such as the display 30.

A memory bus is used by the control unit 62 to access RAM and ROM. RAM is used by control unit 62 as a general storage area and as scratch-pad memory, and can also be used to store input data and processed data. ROM can be used to store instructions or program code followed by control unit 62 as well as other data.

A peripheral bus is used to access the input, output and storage devices used by the inventive device. In the described embodiment(s), these devices include a display 30, a printer device, a floppy disk drive, a hard disk drive, and a network interface. A keyboard controller is used to receive input from a keyboard and send decoded symbols for each pressed key to control unit 62 over the bus.

The display 30 is an output device that displays images of data provided by the control unit 62 via the peripheral bus or provided by other components. The floppy disk drive and the hard disk drive can be utilized to store various types of data. The floppy disk drive facilitates transporting such data to other computer systems, and the hard disk drive permits fast access to large amounts of stored data.

The control unit 62 together with an operating system operate to execute computer code and produce and use data. The computer code and data may reside on RAM, ROM, or hard disk drive. The computer code and data could also reside on a removable program medium and loaded or installed onto the device when needed. Removable program mediums include, for example, CD-ROM, PC-CARD, floppy disk and magnetic tape.

The network interface circuit is utilized to send and receive data over a network connected to other computer systems. An interface card or similar device and appropriate software implemented by control unit 62 can be utilized to connect the device to an existing network and transfer data according to standard protocols.

The keyboard is used by a user to input commands and other instructions to the control unit 62. Other types of user input devices can also be used in conjunction with the present invention. Other types of user input devices can also be utilized in conjunction with the present invention. For example, pointing devices such as a computer mouse, a track ball, a stylus, or a tablet.

The present invention can also be embodied as computer readable code on a computer readable medium. The computer readable medium is any data storage device that can store data which can be thereafter be read by a computer system. Examples of the computer readable medium include read-only memory, random-access memory, magnetic data storage devices such as diskettes, and optical data storage devices such as CD-ROMs. The computer readable medium can also be distributed over a network coupled computer systems so that the computer readable code is stored and executed in a distributed fashion.

As shown in FIGS. 1 through 8 of the drawings, the present invention includes a housing 20. As can be appreciated by one skilled in the art, the housing 20 may be comprised of various shapes, structures and materials. The figures merely illustrate one possible structure of the housing 20 and should not limit the disclosure of the present application.

As shown in FIGS. 1 through 4 of the drawings, a display 30 is positioned within a front portion of the housing 20. The display 30 may be comprised of an illuminated semi-transparent sheet, LED, LCD and other illustrating devices for illustrating messages and/or images.

If an illuminated semi-transparent sheet is utilized within the present invention, an illuminating light 34 is positioned within the housing 20 to illuminate the sheet containing the message such as “PIZZA” printed upon. The illuminating light 34 is electrically connected to a power switch 40 which is electrically connected to a power source 60 such as but not limited to a battery. The manipulation of the power switch 40 activates the illuminating light 34 which illuminates the message and/or image. One or more auxiliary lights 32 may also be included within the housing 20 that are electrically connected to the power switch 40.

A control unit 62 may also be electrically connected between the power switch 40 and the auxiliary lights 32 and the illumination light as shown in FIG. 9 of the drawings. The control unit 62 may be utilized to provide various features such as flashing of the auxiliary lights 32 and/or the illuminating light 34.

The display 30 may also be comprised of a system that allows modification of the message and/or image such as LCD or LED devices. The display 30 is electrically connected to the control unit 62 which allows control of the message and/or image displayed upon the display 30. The displayable message may be modified via various conventional data entry means such as but not limited to control buttons and keyboard.

The control unit 62 may be in communication via the Internet or Intranet to communicate with other electronic devices. The control unit 62 may be programmed to receive notification from the delivery business that the order has been received or is in route to the consumer by displaying a message upon the display 30 or flashing the auxiliary lights 32. Various other systems may be achieved by utilizing the communication features of the control unit 62.

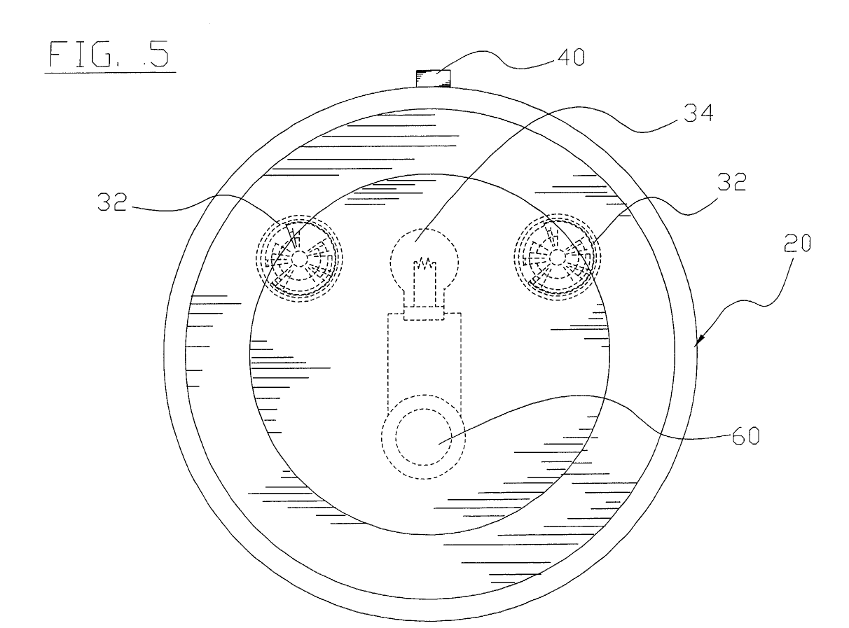

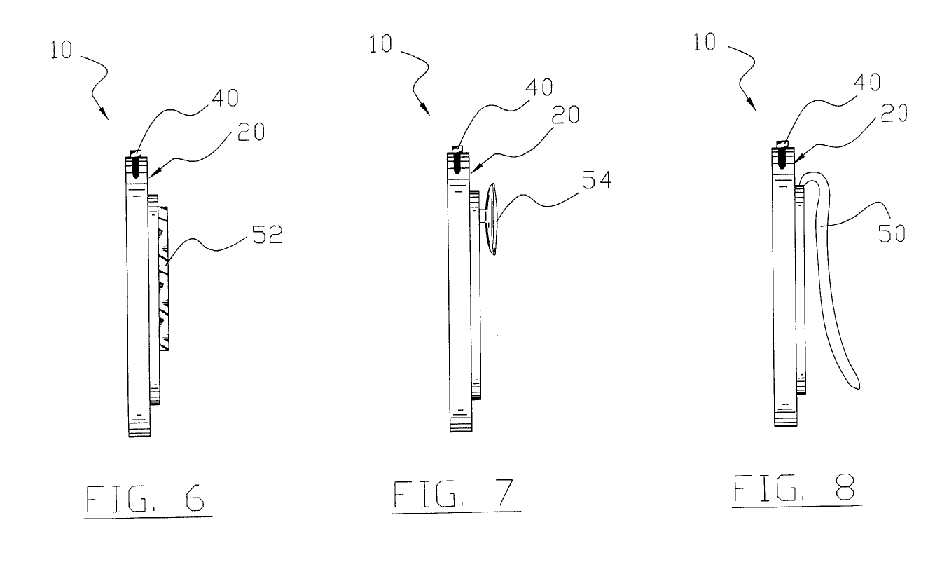

The attaching member secured to the rear portion of the housing 20 may be comprised of various attaching structures such as a clip member 50, at least one magnet 52 or at least one suction cup 54 as illustrated in FIGS. 6 through 8 of the drawings. The clip member 50 is preferably formed to taper outwardly toward the lower portion to provide a stand structure for providing support upon flat surfaces. The at least one suction cup 54 may be utilized to secure the housing 20 to flat surfaces such as a window.

In use, the user positions the housing 20 upon an object such as a door 14 or a mailbox 12 which can be easily viewed from an adjacent road. The user then places an order for goods via conventional means such as by telephone or the Internet. Once the order is placed, the business may send a notification to the control unit 62 indicating that the order has been received. After the goods are prepared and are in route to the consumer the business may also send a signal to the control unit 62 indicating that the delivery of the goods is in route to the consumer wherein the control unit 62 may flash the auxiliary lights 32 or provide a message upon the display 30. If network communications are not utilized within the present invention, the consumer would manually or remotely activate the display 30 via the power switch 40 or computer device. The delivery person travels to the vicinity of the address and then observes the display 30 and/or auxiliary lights 32 indicating the location of the delivery location. The delivery person then makes the delivery of the goods and the consumer thereafter terminates the message illuminated upon the display 30.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A delivery indicator system, comprising:
a housing;
an attachment device secured to said housing for attaching to a surface of an object; and
a display means positioned within said housing for displaying a statement viewable by a delivery person indicating the delivery location.

2. The delivery indicator system of claim 1, wherein said display means is comprised of:
an illuminating light positioned within said housing; and
a semi-transparent sheet having said statement positioned within said housing in front of said illuminating light.

3. The delivery indicator system of claim 2, including a power switch electrically connected to said illuminating light, and a power source electrically connected to said power switch.

4. The delivery indicator system of claim 3, wherein said power source is comprised of at least one battery.

5. The delivery indicator system of claim 2, wherein said display means further includes at least one auxiliary light.

6. The delivery indicator system of claim 5, including a power switch electrically connected to said illuminating light and said at least one auxiliary light, and a power source electrically connected to said power switch.

7. The delivery indicator system of claim 5, including a control unit electrically connected to said illuminating light and said at least one auxiliary light, a power switch electrically connected to said control unit, and a power source electrically connected to said power switch.

8. The delivery indicator system of claim 7, wherein said control unit flashes said at least one auxiliary light.

9. The delivery indicator system of claim 8, wherein said attachment device is comprised of a clip member.

10. The delivery indicator system of claim 9, wherein said clip member tapers outwardly toward a lower portion thereof for providing a stand structure.

11. The delivery indicator system of claim 8, wherein said attachment device is comprised of at least one magnet.

12. The delivery indicator system of claim 8, wherein said attachment device is comprised of at least one suction cup.

13. A delivery indicator system, comprising:
a housing;
an attachment device secured to said housing for attaching to a surface of an object;
a display means positioned within said housing for displaying a statement viewable by a delivery person indicating the delivery location;
a control unit electrically connected to said display means; and
a communication means for connecting said control unit to a computer network.

14. The delivery indicator system of claim 13, wherein said display means is comprised of:
an illuminating light positioned within said housing; and
a semi-transparent sheet having said statement positioned within said housing in front of said illuminating light.

15. The delivery indicator system of claim 14, including a power switch electrically connected to said control unit, and a power source electrically connected to said power switch.

16. The delivery indicator system of claim 15, wherein said power source is comprised of at least one battery.

17. The delivery indicator system of claim 15, wherein said display means further includes at least one auxiliary light.

18. The delivery indicator system of claim 17, wherein said control unit flashes said at least one auxiliary light.

19. The delivery indicator system of claim 18, wherein said attachment device is comprised of a clip member, wherein said clip member tapers outwardly toward a lower portion thereof for providing a stand structure.

20. A method of utilizing a delivery indicator device comprised of a housing, an attachment device secured to said housing for attaching to a surface of an object, and a display means positioned within said housing for displaying a statement viewable by a delivery person indicating the delivery location, comprising the steps of:
(a) positioning said delivery indicator device to a surface of an object in an easily viewable location utilizing said attachment device;
(b) placing an order to a business for delivery of goods or services;
(c) activating said display means to illuminate said statement;
(d) receiving said delivery of goods or services; and
(e) deactivating said display means.
